(19) United States
(12) Patent Application Publication
(10) Pub. No.: US 2007/0114499 A1
(43) Pub. Date: May 24, 2007

(54) Process for producing metal micropowder having particle diameter uniformalized

(75) Inventors: Shinroku Kawasumi, Kanagawa (JP); Shnichiro Kawasumi, Kanagawa (JP)

Correspondence Address: NIXON PEABODY, LLP, 401 9TH STREET, NW, SUITE 900, WASHINGTON, DC, 20004-2128, US

(73) Assignees: Shinroku Kawasumi, Kamakura-shi, Kanagawa (JP); Shinichiro Kawasumi, Hiratsuka-shi, Kanagawa (JP); KOJIMA CHEMICALS CO., LTD., Sayama-shi, Saitama (JP)

(21) Appl. No.: 10/581,084

(22) PCT Filed: Nov. 30, 2004
(86) PCT No.: PCT/JP04/17791

§ 371 Date: May 31, 2006

(30) Foreign Application Priority Data
Dec. 1, 2003 (JP) 2003-401521

(51) Int. Cl. H01B 1/22

(52) U.S. Cl. 252/512

(57) ABSTRACT

Provision of a preparing method for the production of a metal micropowder having a uniform diameter which is of value for preparation of precious metal electrodes. A method for producing a metal micropowder having a uniform particle diameter which is performed sequentially by preparing a colloidal solution which contains two metal (e.g., Ag and Pd) salts having different oxidation-reduction potentials; bringing a reducing agent into contact with the colloidal solution, whereby first precipitating micro-particles of a metal (e.g., Ag) having a relatively low oxidation-reduction potential and then depositing a metal (e.g Pd) having a relatively high oxidation-reduction potential on the micro-particles, to produce double layered particles composed of the micro-particles of a metal of a relatively low oxidation-reduction potential coated with a metal of a relatively high oxidation-reduction potential; and bringing the colloidal solution containing the double layered particles into contact with a third metal (e.g., Ag—Pd, Pt) salt and a reducing agent.

### FIELD OF THE INVENTION

The present invention relates to a method for producing a metal micropowder having a uniform particle diameter. In particular, the invention relates to a method for producing a metal micropowder having a metal coat of palladium, palladium-silver alloy, platinum, silver, or nickel and having a uniform particle diameter.

### BACKGROUND OF THE INVENTION

A micropowder of palladium, palladium-silver alloy, platinum, or silver is a prerequisite metal material for manufacturing an electrode of condenser, an electrode of sensor, or an electrode of IC circuit. A nickel micropowder is of value as electroconductive adhesive for electrically combining electrodes and other constitutional members of a fuel cell of a solid electrode type or a steam electrolyte cell.

Due to the recent requirements of downsizing electronic devices and improving their performances, it is required to make the above-mentioned various electrodes thinner. The electrode having a smaller thickness, naturally, should have a uniform thickness. Therefore, it is required to provide a metal micropowder having a uniform particle diameter. However, there is a problem that it is not easy to produce a micropowder having a uniform particle diameter of a micron(μm) level and particularly a nanometer (nm) level.

Japanese Patent Provisional Publicatiom 5-334911 describes an invention for manufacture of an electrode of high performances, using a mixture of a globular platinum micropowder and an amorphous platinum powder having more fine size. Even in this method, it is desired to employ a platinum powder having the predetermined diameter level and further having a uniform particle diameter.

### SUMMARY OF THE INVENTION

The present invention has an object to provide a method for producing a metal micropowder having a uniform particle diameter, which is particularly of value for manufacturing precious metal electrodes.

The present invention resides in a method for producing a metal micropowder having a uniform particle diameter which comprises the sequential steps of:

preparing an aqueous solution which contains two salts of metals having oxidation-reduction potentials which differ from each other;

bringing a reducing agent into contact with the aqueous solution in the presence of a protective colloid, whereby first precipitating micro-particles of a metal having a relatively low oxidation-reduction potential and then depositing a metal having a relatively high oxidation-reduction potential on the micro-particles, to produce double layered particles comprising the micro-particles of a metal of a relatively low oxidation-reduction potential coated with a metal of a relatively high oxidation-reduction potential; and

bringing the colloidal solution containing the double layered particles into contact with a third metal salt and a reducing agent.

The invention further resides in a method for producing a metal micropowder having a uniform particle diameter which comprises bringing a colloidal solution containing double layered particles comprising micro-particles of a metal of a relatively low oxidation-reduction potential coated with a metal of a relatively high oxidation-reduction potential into contact with a third metal salt and a reducing agent.

The invention furthermore resides in a metal micro-particle comprising a core particle of silver, copper or tin which is coated with a palladium layer, which is further coated with palladium, palladium-silver alloy, platinum, silver, or nickel.

The invention furthermore resides in a metal micropowder comprising a plurality of the metal micro-particles of the invention. The metal micropowder preferably has a mean diameter in the range of 0.1 to 0.9 μm, particularly, in the range of 0.2 to 0.8 μm. Moreover, the metal micropowder preferably shows a normal diameter distribution σ_{g} is not more than 2.0, more preferably not more than 1.9, most preferably not more than 1.8.

The metal micropowder of the invention can be mixed with a binder such as ethylcellulose and a spreading agent such as terpineol to prepare an electro-conductive paste which is of value for manufacturing electrodes.

The invention furthermore resides in a method for producing a metal micropowder which comprises the sequential steps of:

preparing an aqueous solution which contains two salts of metals having oxidation-reduction potentials which differ from each other; and

bringing a reducing agent into contact with the aqueous solution in the presence of a protective colloid, whereby first precipitating micro-particles of a metal having a relatively low oxidation-reduction potential and then depositing a metal having a relatively high oxidation-reduction potential on the micro-particles, to produce double layered particles comprising the micro-particles of a metal of a relatively low oxidation-reduction potential coated with a metal of a relatively high oxidation-reduction potential.

The final step of the method of the invention for a metal micropowder, in which a colloidal solution containing double layered particles comprising micro-particles of a metal of a relatively low oxidation-reduction potential coated with a metal of a relatively high oxidation-reduction potential into contact with a third metal salt and a reducing agent, can be preferably carried out by one of the following procedures:

the colloidal solution containing double layered particles is first mixed with a reducing agent, and then a solution of a third metal salt is added to the mixed solution, while the latter solution is kept under mixing —this procedure can be named “reverse addition method”; and

a reducing agent and a solution of a third metal salt are simultaneously added to the colloidal solution containing double layered particles under stirring —this procedure can be named “simultaneous addition method.

In the invention, it is preferred that the metal having a relatively low oxidation-reduction potential is silver, copper, or tin, and the metal having a relatively high oxidation-reduction potential is palladium. The third metal preferably is palladium, palladium-silver alloy, platinum, silver, or nickel.

### EFFECTS OF THE INVENTION

The method of the invention for producing a metal micropowder can produce easily a metal micropowder having a uniform particle diameter. The metal micropowder of the invention can be utilized for preparing an electro-conductive paste favorably employable for manufacturing thin electrodes.

### BRIEF DESCRIPTION OF THE DRAWINGS

FIG. 1 is an electromicroscopic photo of a micropowder powder (mean particle diameter: 0.4 μm) comprising a palladium/silver double layered particle coated with palladium-silver alloy, which was produced in Example 1.

FIG. 2 is an electromicrosccpic photo of a micropowder (mean particle diameter: 0.4 μm) comprising a palladium/silver double layered particle coated with palladium which was produced in Example 2.

FIG. 3 is an electromicroscopic photo of a micropowder (mean particle diameter: 0.8 μm) comprising a palladium/silver double layered particle coated with palladium metal which was produced in Example 3.

FIG. 4 is an electromicroscopic photo of a micropowder (mean particle diameter: 0.2-0.3 μm) comprising a silver/copper double layered particle coated with nickel metal which was produced in Example 4.

FIG. 5 is an electromicroscopic photo of a micropowder (mean particle diameter: 0.4 μm) comprising a palladium/silver double layered particle coated with platinum which was produced in Example 5.

FIG. 6 is an electromicroscopic photo of a micropowder (mean particle diameter: 0.54 μm) comprising a palladium/silver double layered particle coated with platinum which was produced in Example 6.

FIG. 7 indicates a particle diameter distribution of a micropowder comprising a palladium/silver double layered particle coated with platinum which was produced in Example 6.

FIG. 8 is an electromicroscopic photo of a micropowder (mean particle diameter: 0.8 μm) comprising a palladium/silver double layered particle coated with platinum which was produced in Example 7.

FIG. 9 is an electromicroscopic photo of a platinum micropowder which was produced in Comparison Example 1.

FIG. 10 indicates a particle diameter distribution of a platinum micropowder produced in Comparison Example 1.

### DETAILED DESCRIPTION OF THE INVENTION

The method of the invention for producing a metal micropowder comprises:

a first step of preparing an aqueous solution which contains two salts of metals having oxidation-reduction potentials which differ from each other;

a second step of bring a reducing agent into contact with the aqueous solution in the presence of a protective colloid, whereby first precipitating micro-particles of a metal having a relatively low oxidation-reduction potential and then depositing a metal having a relatively high oxidation-reduction potential on the micro-particles, to produce double layered particles comprising the micro-particles of a metal of a relatively low oxidation-reduction potential coated with a metal of a relatively high oxidation-reduction potential; and

a third step of bringing the colloidal solution containing the double layered particles into contact with a third metal salt and a reducing agent.

According to the method of the invention for producing a metal micropowder having a uniform particle diameter, an aqueous solution containing two salts of metals having different oxidation-reduction potential and a protective colloid is brought into contact with a reducing agent, so as to first reduce a salt of a metal having a relatively low oxidation-reduction potential, precipitating metal fine particles having a uniform particle diameter; then a metal of a relatively high oxidation-reduction potential is deposited on the previously precipitated metal fine particles, to prepare double layered metal particles having a uniform particle diameter, and finally a metal is deposited and coated over the surface of the double layered metal particles by reducing the metal salt. In the method of the invention, the colloidal solution serves to keep the deposited and formed metal fine particles from growing and coagulating, so as to produce a metal micropowder in which fine metal particles are well dispersed.

Each step of the method of the invention for producing a metal micropowder having a uniform particle diameter is described below in more detail.

In the first step, an aqueous solution containing salts of metals having oxidation-reduction potentials differing from each other is prepared. Examples of the combinations of two metals having different oxidation-reduction potentials include a combination of silver, copper or tin (which has a relatively low oxidation-reduction potential) and palladium (which has a relatively high oxidation-reduction potential), and a combination of copper (which has a relatively low oxidation-reduction potential) and silver (which has a relatively high oxidation-reduction potential). In other words, the “high” and “low” in the combination of the two metal mean relative levels. The salts of the metals are water-soluble salts. However, the solubility in water is not necessarily high. Examples of the water-soluble salts include sulfate, nitrate, hydrochloride, carbonate, organic acid salts, and various complexes. A ratio of a salt of metal having a relatively low oxidation-reduction potential and a salt of metal having a relatively high oxidation-reduction potential generally is in the range of 1:10 to 1:100,000 (former:latter), preferably in the range of 1:100 to 1:10,000.

Subsequently, a reducing agent is brought into contact with the above-mentioned aqueous metal salt solution in the presence of a protective colloid. There is no specific limitation with respect to the temperature in the contact procedure. However, a surrounding temperature of 10 to 40° C. is preferred, and a temperature of 20 to 30° C. is more preferred. The protective colloid serves to efficiently keep the deposited metal fine particles from coagulating, as is described hereinbefore. Examples of the protective colloids having such function include water-soluble cellulose derivatives such as carboxy-methylcellulose (CMC), proteins such as gelatin, and synthetic polymers such as polyvinyl alcohol. A preferred reducing agent is an organic reducing agent such as hydrazine hydrate.

Upon contact of a reducing agent with the aqueous metal salt solution in the presence of a protective colloid, the salt of metal having a low oxidation-reduction potential is reduced to precipitate fine metal particles having a uniform particle diameter, and a salt of metal having a high oxidation-reduction potential is then deposited around the previously precipitated fine metal particles. The growth of thus prepared double layered particles is controlled to produce double layered particles having a uniform particle diameter.

Subsequently, a reducing agent and a salt of a third metal forming a surface layer are brought into contact with the colloidal solution containing the double layered metal particles so that the third metal is deposited and coated on the double layered metal particles. There is no specific limitation with respect to the temperature of the contact procedure. However, a surrounding temperature of 10 to 40° C. is preferred, and a temperature of 20 to 30° C. is more preferred. Examples of the third metals include palladium, palladium-silver alloy, platinum, silver, and nickel. Examples of the metal salts include sulfate, nitrate, hydrochloride, carbonate, organic acid salts, and various complexes. The reducing agent preferably is an organic reducing agent such as the aforementioned hydrazine hydrate.

The procedure for bringing the double layered metal particles into contact with the salt of third metal and reducing agent in the presence of a protective colloid is preferably carried out by one of the following methods:

(1) the colloidal solution containing double layered particles is first mixed with the reducing agent, and then the solution of the third metal salt is added to the mixed solution, while the latter solution is kept under mixing (reverse addition method); and

(2) the reducing agent and the solution of the third metal salt are simultaneously added to the colloidal solution containing double layered particles under stirring (simultaneous addition method).

These addition methods are described in detail in Japanese Patent Provisional Publication 2002-334614.

The metal micropowder produced by the method of the invention comprises three layered particles which are composed of a fine particle nucleus (center layer) of a metal having a relatively low oxidation-reduction potential, an intermediate layer formed around the center layer which comprises a metal having a relatively high oxidation-reduction potential, and a surface layer formed around the intermediate layer. The first formed fine particle nucleus is produced by reduction of the metal salt. Growth and coagulation of the fine particle nuclei are inhibited in the presence of a protective colloid, so that there are produced fine particle nuclei having a uniform diameter in the aqueous solution. Further, coagulation of the produced double layered metal particles is also inhibited in the presence of a protective colloid. Accordingly, there are produced double layered metal particles having a uniform particle diameter. Furthermore, there are finally produced three layered metal particles (metal micropowder) having a uniform particle diameter due to the presence of the protective colloid.

### EXAMPLES

### Example 1

### Production of Metal Micropowder Having Silver-Palladium alloy surface layer (mean particle diameter: 0.4 μm)

(1) Preparation of Aqueous Palladium Salt Solution

In a 500 mL-volume beaker were placed and stirred with a magnetic stirrer dichlorodiamine palladium(II) [cis-[PdCl₂ (NH₃)² (II)] in an amount of 50 g (in terms of palladium amount) and 300 mL of water. Subsequently, 100 mL of conc. aqueous ammonia (NH₄OH) was placed in the beaker, and the beaker was sealed with a wrapping film. The content in the beaker was stirred for one hour. The content in the beaker was almost dissolved, and the content was filtered. The solution was diluted with water, to give 500 mL of an aqueous palladium salt solution.

(2) Preparation of Aqueous Silver Salt Solution

In a 500 mL-volume brown bottle were placed 6.67 g (corresonding to 5 g in terms of silver amount) of silver chloride and an aqueous solution (in an amount of 400 mL which was prepared by diluting 100 mL of a conc. aqueous ammonia with water). The brown bottle was shielded from light by means of a resin film and an aluminum foil. The content in the bottle was stirred with a magnetic stirrer. Subsequently, water was added to give 500 mL of an aqueous silver chloride solution.

(3) Preparation of Protective Colloid

In a 5 L-volume beaker was placed 4 L of water. Then, 40 g of carboxylmethylcellulose (CMC) was portion-wise added to the water to give an aqueous CMC solution, while the water was vigorously stirred. The stirring was continued for one hour, to prepare the protective colloid.

(4) Preparation of Dispersion Containing Palladium/Silver Double Layered Particles

The whole (50 g in terms of palladium amount) of the aqueous palladium salt solution was added to the whole of the protective colloidal solution prepared above, while the protective colloidal solution was kept under stirring. Then, 2.5 mL (corresponding to 25 mg in terms of silver amount) of the aqueous silver salt solution was portionwise added. The stirred solution was slowly warmed to 30° C. under stirring. When the temperature of the stirred solution reached 30° C., an aqueous hydrazine hydrate solution (15 mL/75 mL) was added. The aqueous mixture was further stirred at 30-40° C. for one hour. By this procedure, there was prepared a dispersion containing palladium/silver double layered particles in which a palladium layer was placed around a fine silver particle. Thus prepared dispersion was stored after tightly wrapping with a resin film.

(5) Preparation of Aqueous Solution Containing Silver Metal Salt and Palladium Metal Salt

To an aqueous palladium nitrate (Pd(NO₃)₂) solution in an amount of 60 g (in terms of palladium metal amount) was added 500 mL of water, and the mixture was stirred. To the stirred mixture was further added slowly 240 mL of an aqueous ammonia under stirring. Subsequently, solid silver nitrate in an amount of 140 g (in terms of silver metal amount) was added, and the mixture was stirred until the mixture turned into a solution. After the dissolution of the silver nitrate was confirmed, 200 mL of an aqueous ammonia was added. The mixture was stirred until a clear solution containing palladium nitrate and silver nitrate was prepared. After stirring was complete, water was added to the solution containing palladium nitrate and silver nitrate to give 1.2 L of an aqueous solution.

(6) Production of Metal Micropowder Having Silver-Palladium Alloy Surface Layer

To 640 mL of 1% aqueous CMC solution was added 340 mL of the dispersion of palladium/silver double layered particles prepared in (4) above, and the mixture was sufficiently stirred. To the resulting colloidal solution were subsequently added 50 mL of hydrazine hydrate and 160 mL of water. The resulting diluted colloidal solution (reaction mother solution) was controlled to have a temperature of 26 to 30° C.

The aqueous solution containing silver salt and palladium salt (prepared in (5) above) was portionwise added to the temperature-controlled reaction mother solution for 60 minutes, while the temperature of the reaction mixture was kept at a level not higher than 40° C. After the addition was complete, the reaction mixture was stirred for 90 mixture for aging.

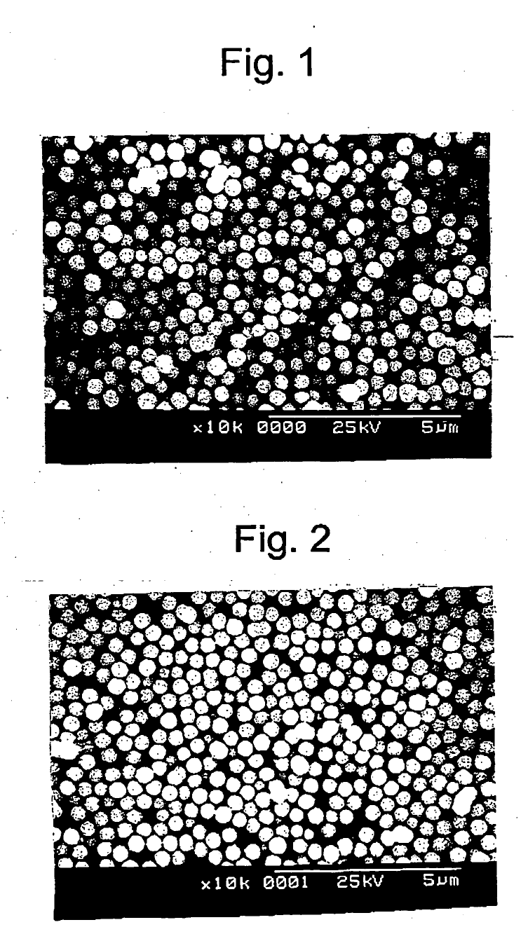

After the aging was complete, CMC was removed, and the produced metal micropowder was collected by filtration and dried. The microscopic photo of the obtained metal micropowder is shown in FIG. 1. The mean particle diameter of the metal micropowder was 0.4 μm. As is apparent from FIG. 1, the particle diameters were sufficiently uniform. It was further confirmed that the surface layer of the micro particle was made of silver-palladium alloy.

### Example 2

### Production of Metal Micropower Having Palladium Surface Layer (Mean Particle Diameter: 0.4 μm)

(1) Preparation of Dispersion Containing Palladium/Silver Double Layered Particles

The procedures of Example 1 were repeated using the aqueous palladium salt solution, aqueous silver halide solution, and protective solution, to prepare a dispersion containing palladium/silver double layered particles.

(2) Preparation of Aqueous Palladium Salt Solution

To an aqueous palladium nitrate (Pd(NO₃)₂) solution in an amount of 200 g (in terms of palladium metal amount) was added 1 L of water, and the mixture was stirred. While the stirring was continued, 1.2 L of aqueous ammonia was added slowly to prepare an aqueous palladium salt solution.

(3) Preparation of Aqueous Hydrazine Hydrate water was added to 100 mL of hydrazine hydrate, to prepare 500 mL of an aqueous hydrazine hydrate solution.

(4) Production of Metal Micropowder Having Palladium Surface Layer

To 890 mL of 1% aqueous CMC solution was added 355 mL of the dispersion of palladium/silver double layered particles obtained in (1) above, and the mixture was sufficiently stirred and kept at 30° C.

The resulting colloidal solution (reaction mother solution) was stirred. To the stirred solution were simultaneously added the aqueous palladium salt solution obtained in (2) above and the aqueous hydrazine hydrate solution obtained in (3) above. After the addition was complete, the mixture was further stirred for 1.5 hours, while the temperature was kept in the range of 30 to 40° C.

CMC was removed by washing, and the produced metal micropowder was collected by filtration and dried. The microscopic photo of the obtained metal micropowder is shown in FIG. 2. The mean particle diameter of the metal micropowder was 0.4 μm. As is apparent from FIG. 2, the particle diameters were sufficiently uniform. It was further confirmed that the surface layer of the micro particle was made of palladium metal.

### Example 3

### Production of Metal Micropowder Having Palladium Surface Layer (Mean Particle Diameter: 0.8 μm)

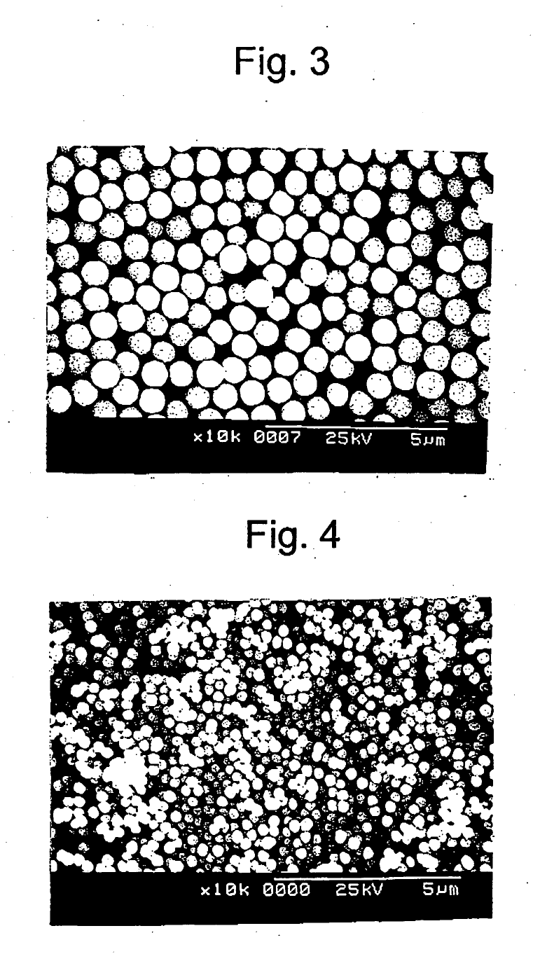

The procedures of Example 2 were repeated except that 100 mL of the dispersion of palladium/silver double layered particles was used in the preparation of a metal micropowder having palladium surface layer in Example 2- (4). The microscopic photo of the obtained metal micropowder is shown in FIG. 3. The mean particle diameter of the metal micropowder was 0.8 μm. The particle diameters were sufficiently uniform.

### Example 4

### Production of Metal Micropowder Having Nickel Surface Layer (Mean Particle Diameter: 0.2-0.3 μm)

(1) Preparation of Aqueous Silver Salt Solution

In a 500 mL-volume beaker were placed silver nitrate (AgNO₃) in an amount of 50 g (in terms of silver metal amount) and 300 mL of water. Subsequently, 100 mL of aqueous ammonia was added. The mixture was stirred for one hour, while the beaker was sealed with a resin film. Subsequently, water was added to the mixture to make 500 mL of an aqueous mixture.

(2) Preparation of Aqueous Copper Salt Solution

In a beaker was placed copper nitrate (CU(NO₃)₂) in an amount of 5 g (in terms of copper amount), and further placed 400 mL of an aqueous a solution (prepared by diluting 100 mL of a conc. aqueous ammonia with water). The mixture was stirred for one hour, while the beaker was sealed with a resin film. Subsequently, water was added to the mixture to make 500 mL of an aqueous mixture.

(3) Preparation of Protective Colloid

In a 5 L-volume beaker was placed 4 L of water. Then, 4 g of carboxymethylcellulose (CMC) was portionwise added to the water to give an aqueous CMC solution, while the water was vigorously stirred. The stirring was continued for one hour, to prepare the protective colloid.

(4) Preparation of Dispersion Containing Silver/Copper Double Layered Particles

The whole (50 g in terms of silver amount) of the aqueous silver salt solution was added to the whole of the protective colloidal solution prepared above, while the protective colloidal solution was kept under stirring. Then, 2.5 mL (25 mg in terms of copper amount) of the aqueous copper salt solution was portionwise added. The stirred solution was slowly warmed to 30° C. under stirring. When the temperature of the stirred solution reached 30° C., an aqueous hydrazine hydrate solution (7.5 mL/75 mL) was added. The aqueous mixture was further stirred at 30-40° C. for one hour. By this procedure, there was prepared a dispersion containing silver/copper double layered particles in which a silver layer was placed around a fine copper particle. Thus prepared dispersion was stored after tightly wrapping with a resin film.

(5) Preparation of an Aqueous Solution Containing Nickel Salt

In a 2 L-volume beaker were successively placed nickel carbonate (NiCO_{3·}2Ni(OH)₂·4H₂O) in an amount of 50 g (in terms of nickel metal amount) and 1.5 L of water. The mixture was stirred with a homogenizer at 80° C., so as to disperse and pulverize nickel carbonate. Thus, an aqueous nickel salt solution containing a pulverized nickel salt was prepared.

(6) Preparation of Aqueous Hydrazine Hydrate

Water was added to 100 mL of hydrazine hydrate, to prepare 500 mL of an aqueous hydrazine hydrate solution.

(7) Production of Metal Micropowder Having Nickel Surface Layer

To 1,000 mL of 1% aqueous CMC solution was added 300 mL of the dispersion of silver/copper double layered particles obtained in (4) above, and the mixture was sufficiently stirred and kept at 30°0 C.

The resulting colloidal solution (reaction mother solution) was stirred. To the stirred solution were simultaneously added the aqueous nickel salt solution obtained in (5) above and the aqueous hydrazine hydrate solution obtained in (3) above. After the addition was complete, the mixture was further stirred, while the temperature was kept in the range of 30 to 40° C.

CMC was removed by washing, and the produced metal micropowder was collected by filtration and dried. The microscopic photo of the obtained metal micropowder is shown in FIG. 4. The mean particle diameter of the metal micropowder was 2 to 3 μm. As is apparent from FIG. 4, the particle-diameters were sufficiently uniform. It was further confirmed that the surface layer of the micro particle was made of nickel metal.

### Example 5

### Production of Metal Micropowder Having Platinum Surface Layer (Mean Particle Diameter: 0.4 μm)

(1) Preparation of Dispersion Containing Palladium/Silver Double Layered Particles

The procedures of Example 1 were repeated using the aqueous palladium salt solution, aqueous silver halide solution, and protective solution, to prepare a dispersion containing palladium/silver double layered particles.

(2) Preparation of Aqueous Platinum Salt Solution

Water was added to dichlorotetraamnine platinum (II) to prepare 2 L of an aqueous platinum salt solution containing 500 g of platinum metal.

(3) Preparation of Aqueous Hydrazine Hydrate

Water was added to 225 mL of hydrazine hydrate, to prepare 500 mL of an aqueous hydrazine hydrate solution.

(4) Production of Metal Micropowder Having Platinum Surface Layer

To 890 mL of 1% aqueous CMC solution was added 340 mL of the dispersion of palladium/silver double layered particles obtained in (1) above, and the mixture was sufficiently stirred and kept at 30° C.

The resulting colloidal solution (reaction mother solution) was stirred. To the stirred solution were simultaneously added the aqueous platinum salt solution obtained in (2) above and the aqueous hydrazine hydrate solution obtained in (3) above. After the addition was complete, the mixture was further stirred for 1.5 hours, while the temperature was kept in the range of 30 to 40° C.

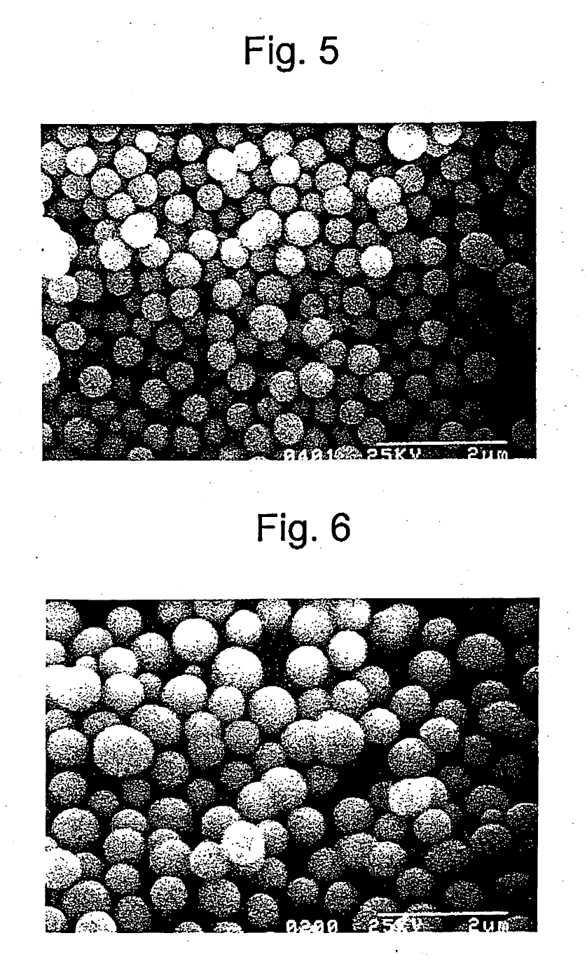

CMC was removed by washing, and the produced metal micropowder was collected by filtration and dried. The microscopic photo of the obtained metal micropowder is shown in FIG. 5. The mean particle diameter of the metal micropowder was 0.4 μm. As is apparent from FIG. 5, the particle diameters were sufficiently uniform. It was further confirmed that the surface layer of the micro particle was made of platinum metal.

### Example 6

### Production of Metal Micropowder Having Platinum Surface Layer (Mean Particle Diameter: 0.54 μm)

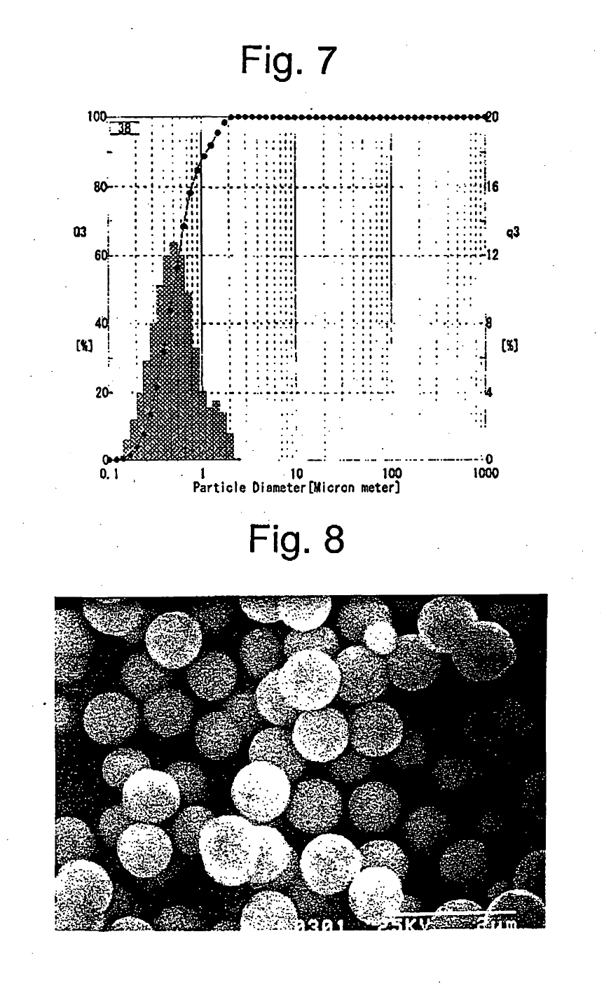

The procedures of Example 5- (4) were repeated using 100 mL of the dispersion of palladium/silver double layered particles, to produce a metal micropowder. The microscopic photo of the obtained metal micropowder is shown in FIG. 6. The mean particle diameter of the metal micropowder was 0.54 μm. As is apparent from FIG. 6, the particle diameters were sufficiently uniform. It was further confirmed that the surface layer of the micro particle was made of platinum metal. The diameter distribution of the metal micropowder is shown in FIG. 7. The normal distribution 50% was 0.54 μm, and the normal distribution σ_{g} was 1.76.

### Example 7

### Production of Metal Micropowder Having Platinum Surface Layer (Mean Particle Diameter: 0.8 μm)

The procedures of Example 5-(4) were repeated using 50 mL of the dispersion of palladium/silver double layered particles, to produce a metal micropowder. The microscopic photo of the obtained metal micropowder is shown in FIG. 8. The mean particle diameter of the metal micropowder was 0.8 μm. As is apparent from FIG. 8, the particle diameters were sufficiently uniform. It was further confirmed that the surface layer of the micro particle was made of platinum metal.

### Comparison Example 1

The aqueous platinum salt solution obtained in Example 5-(2) and the aqueous hydrazine hydrate solution obtained in Example 5-(3) were mixed. After the mixture was obtained, the mixture was further stirred for 1.5 hours, while the temperature was kept in the range of 30 to 40° C.

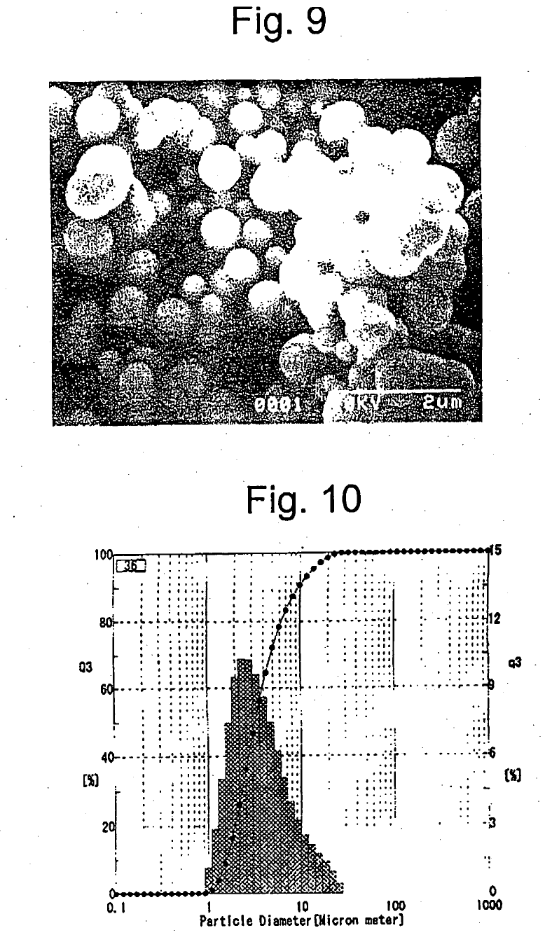

The produced platinum micropowder was collected by filtration and dried. The microscopic photo and the diameter distribution of the obtained platinum micropowder are shown in FIG. 9 and FIG. 10, respectively. The normal distribution 50% was 3.8 μm, and the normal distribution σ_{g} was 2.06.

### Evaluation Example

### Preparation of Electro-Conductive Paste, and Preparation and Evaluation of Electrode

Each of the metal micropowders having platinum surface layer (platinum-coated metal micropowder) obtained in Examples 5 and 7 and Comparison Example 1 was processed to prepare an electro-conductive paste under the following conditions.

1) Essential composition of electro-conductive paste

Inorganic component/ethyl cellulose/terpineol=85/2/13 (weight ratio)

The inorganic component was a platinum-coated metal micropowder/alumina powder=95/5 (weight ratio).

2) Prepared Electro-Conductive Paste

Electro-conductive paste 1: the platinum-coated metal micropowder of Comparison Example 1 was used.

Electro-conductive paste 2: the platinum-coated metal micropowder of Example 7 (mean particle diameter: 0.8 μm) was used.

Electro-conductive paste 3: the platinum-coated metal micropowder of Example 5 (mean particle diameter: 0.4 μm) was used.

Electro-conductive paste 4: a mixture of the platium-coated metal micropowder of Example 7 (mean particle diameter: 0.8 μm) and the platinum-coated metal micropowder of Example 5 (mean particle diameter: 0.4 μm) in a weight ratio of 9:1 was used. This paste was prepared to make the particles under closest packing.

3) Manufacture of Electrode

The electro-conductive paste was printed on a ceramic substrate by screen printing and heated to 1,550° C. for 2 hours, to give an electrode having a thickness of approx. 15 μm.

4) Resistance of Electrode

Electrode prepared from Electro-conductive paste 1: 60 μmΩ·cm
Electrode prepared from Electro-conductive paste 2: 40 μmΩ·cm
Electrode prepared from Electro-conductive paste 3: 35 μmΩ·cm
Electrode prepared from Electro-conductive paste 4: 20 μmΩ·cm
Electrode prepared from pure platinum powder (reference): 17 μmΩ·cm

What is claimed is:

1. A method for producing a metal micropowder having a uniform particle diameter which comprises the sequential steps of:
preparing an aqueous solution which contains two salts of metals having oxidation-reduction potentials which differ from each other;
bringing a reducing agent into contact with the aqueous solution in the presence of a protective colloid, whereby first precipitating micro-particles of a metal having a relatively low oxidation-reduction potential and then depositing a metal having a relatively high oxidation-reduction potential on the micro-particles, to produce double layered particles comprising the micro-particles of a metal of a relatively low oxidation-reduction potential coated with a metal of a relatively high oxidation-reduction potential; and
bringing the colloidal solution containing the double layered particles into contact with a third metal salt and a reducing agent.

2. A method for producing a metal micropowder having a uniform particle diameter which comprises bringing a colloidal solution containing double layered particles comprising micro-particles of a metal of a relatively low oxidation-reduction potential coated with a metal of a relatively high oxidation-reduction potential into contact with a third metal salt and a reducing agent.

3. The method of claim 1 or 2, in which the colloidal solution containing the double layered particles is first mixed with the reducing agent and then a solution of the third metal salt is added to the mixed solution.

4. The method of claim 1 or 2, in which the reducing agent and a solution of the third metal salt are simultaneously added to the colloidal solution containing the double layered particles under mixing.

5. The method of claim 1 or 2, in which the metal having a relatively low oxidation-reduction potential is silver, copper, or tin, and the metal having a relatively high oxidation-reduction potential is palladium.

6. The method of claim 1 or 2, in which the third metal is palladium, palladium-silver alloy, platinum, silver, or nickel.

7. A metal micro-particle comprising a core particle of silver, copper or tin which is coated with a palladium layer, which is further coated with palladium, palladium-silver alloy, platinum, silver, or nickel.

8. A metal micropowder comprising a plurality of the metal micro-particles of claim 7.

9. The metal micropowder of claim 8, which has a mean particle diameter in the range of 0.1 to 0.9 μm.

10. The metal micropowder of claim 8, which has a mean particle diameter in the range of 0.2 to 0.8 μm.

11. The metal micropowder of claim 9, in which a normal particle diameter distribution σ_{g} is not more than 2.0.

12. The metal micropowder of claim 9, in which a normal particle diameter distribution σ_{g} is not more than 1.9.

13. An electro-conductive paste comprising a metal micropowder of any one of claims 8 to 12.

14. A method for producing a metal micropowder which comprises the sequential steps of:
preparing an aqueous solution which contains two salts of metals having oxidation-reduction potentials which differ from each other; and
bringing a reducing agent into contact with the aqueous solution in the presence of a protective colloid, whereby first precipitating micro-particles of a metal having a relatively low oxidation-reduction potential and then depositing a metal having a relatively high oxidation-reduction potential on the micro-particles, to produce double layered particles comprising the micro-particles of a metal of a relatively low oxidation-reduction potential coated with a metal of a relatively high oxidation-reduction potential.

15. The method of claim 14, in which the metal having a relatively low oxidation-reduction potential is silver, copper, or tin, and the metal having a relatively high oxidation-reduction potential is palladium.
